(19) United States
(12) Patent Application Publication
(10) Pub. No.: US 2012/0135254 A1
(43) Pub. Date: May 31, 2012

(54) SUBSTRATE BODY WITH AN ANTIMICROBIAL SURFACE INCLUDING ABSORBENTS EMBEDDED THEREIN

(76) Inventor: KAMI KLAUS KAHROM, Erzhausen (DE)

(21) Appl. No.: 13/304,871

(22) Filed: Nov. 28, 2011

(30) Foreign Application Priority Data
Nov. 29, 2010 (DE) 20 2010 015 893.1
Apr. 21, 2011 (DE) 20 2011 005 569.8

(51) Int. Cl. B32B 38/08; B32B 13/02; B05D 1/12

(52) U.S. Cl. 428/454; 427/180; 156/279; 428/688

(57) ABSTRACT

In a substrate body with an antimicrobial surface area consisting of an antimicrobially effective material, spherical adsorbents in the form of activated carbon spheres are embedded in the surface of the antimicrobially effective material for retaining any microbes on the substrate body until they are eliminated by the antimicrobially effective material.

### BACKGROUND OF THE INVENTION

The invention resides in a substrate body with an antimicrobial surface layer having absorbents embedded therein. The substrate body may be for example a door handle. The surface layer may be formed by a coating applied to the substrate body or formed by an uppermost material layer of the substrate body.

It is well-known that surfaces which are usually contacted by people such as door handles, light switches, toilet flushing handles etc. are carriers and transmitters of bacteria, viruses and fungi. When for example a contaminated hand touches a door handle, bacteria and viruses remain there and are transferred to the next hand that touches the door handle.

Antimicrobial surfaces either in the form of antimicro-surface coatings of objects or in the form of surfaces of objects consisting of antimicrobial materials are known. They are special in that they consist of noble metals or plastic materials which contain additives which release noble metal ions with antibacterial properties. Such antibacterial surfaces may for example be manufactured by powder coatings of corresponding materials or they may be surfaces of objects of copper alloys or plastic materials as they are commercially available under the mark ROWA care which include an antimicrobial additive as effective substance. Such materials have the property to eliminate bacteria, viruses and fungi within a few hours.

For surfaces of objects which are frequently used such as door handles in public buildings or restroom doors a period of even a few hours needed for an effective killing of microbes is too long. Since before the antibacterial effect can occur, new germs are deposited by the next person using the object.

It is the object of the present invention to provide a body of the above referred to categories with an antibacterial surface which provides for a rapidly effective antibacterial action so as to achieve an effective prevention of a transmission of microbes even if the body is contacted by different people relatively often and in relatively short intervals.

### SUMMARY OF THE INVENTION

In a substrate body with a surface consisting of an antimicrobially effective material, spherical adsorbents in the form of activated carbon spheres are embedded in the surface of the antimicrobial material for retaining any microbes on the substrate body until they are eliminated or destroyed by the antimicrobially effective material.

The invention is based on the consideration that it is important for the prevention of a transmission of microbes that they are not released from a body or an object that is that they are retained on the surface so that they cannot be transferred from the surface of the object to the next person before they are killed by the antibacterial material of the object.

This is achieved in accordance with invention by the embedment of the spherical absorbents in the form of activated carbon spheres in the antibacterial surface material or coating. The spherical absorbents have the effect to adsorb microbes deposited on the surface and retain them there until they are eliminated by the metal ions released by the antibacterial material.

In accordance with the invention, the spherical adsorbents embedded in the antibacterial surface are in the form of activated carbon spheres.

Spherical adsorbents are known per se. They are used widely for example in the military where they are applied to clothing for adsorbing biological or chemical weapon materials so that these materials cannot penetrate the clothing M and reach the skin of the soldiers.

The present invention advantageously combines the antibacterial effects of such surface materials with the adsorptive properties of spherical adsorbents.

### DESCRIPTION OF EXEMPLARY EMBODIMENTS

The spherical adsorbents to be used in connection with the present invention can be in the form of synthetic resin spheres which are accurately reproducible by a selection of the manufacturing process parameters. The resin spheres are heated in rotary kilns to about 1700° C. In this way, an open-pore spherical carbon body is produced which is wear and pressure resistant. The result is an activated carbon sphere. With a corresponding selection of the materials and temperature curves used, the formation of the pores can be influenced. For the purpose of the present invention, the pores are so arranged that the microbes deposited on the surface are rapidly moved to the interior where they are effectively exposed to the antibacterial material. The activated carbon spheres have an enormously large inner surface. Considered purely mathematically, one gram of activated carbon spheres has an inner surface corresponding to the surface area of more than 5 tennis courts.

For the manufacture of an antimicrobial coating with embedded spherical adsorbents in accordance with the present invention substrate bodies such as door handles of a temperature-resistant material such as metal or glass are coated with an antibacterial powder which is deposited on the substrate body. The body is then heated until the powder coating assumes a gel-like state. In this gel state of the powder coating then the spherical adsorbents are applied to the surface. The application of the spherical adsorbents to the surface should be as uniform as possible and the activated carbon spheres should be about half-way embedded and anchored in the gelatin powder mass. Since the adsorbents are highly temperature-resistant, they may also be applied to antibacterial copper or other noble metal surfaces in a viscous state thereof for obtaining the same effect. If, for example, the body of a door handle consists of antimicrobial copper or a copper alloy or another noble metal, the surface area of the substrate body can be heated to a viscous state and then the adsorbents can be directly applied to the substrate body to achieve the same effect.

If the substrate body does not consist of a temperature-resistant material, it is also possible to apply the antimicrobial additive including the spherical adsorbents to the substrate body by means of a suitable cement.

Although in such a case, the fixing of the material on the substrate body is not as good and durable as it is in connection with the embodiment of the adsorbent spheres in heat-resistant materials as described above, it works reasonably well and, as a result, provides for a substantial extension of the field in which the present invention can find application since, in this way, also materials which are not heat resistant such as plastic materials, cardboard or glass can be provided with an antibacterial coating.

In this way, a surface layer can be formed which combines an antimicrobial and an adsorption effect and which retains microbes so that they are not passed on until they are eliminated by the microbe-killing antimicrobial effect of the antimicrobial material.

The antimicrobial coating with embedded spherical adsorbents as disclosed above consist either of a coating of a material with the spherical adsorbents embedded therein applied to a substrate body or a surface layer of a substrate M body consisting of an antimicrobial material which body has been heated and whose surface has been modified by the embodiment of the spherical adsorbents.

What is claimed is:

1. A substrate body with an antimicrobial surface consisting of an antimicrobially effective material layer including at the surface thereof adsorbents in the form of activated carbon spheres embedded in the antimicrobial surface.

2. The substrate body with an antimicrobial surface as claimed in claim 1, wherein the antimicrobial surface is formed by a coating including the antimicrobial material applied to the substrate body and spherical adsorbents are embedded in the coating including the antimicrobial material.

3. The substrate body according to claim 1, wherein at least an uppermost material layer of the substrate body consists of a material which includes the antimicrobially effective material and the spherical adsorbents are embodied in the uppermost layer material.

4. The substrate body according to claim 1, wherein the antimicrobially effective material with the embedded spherical adsorbents is fixed to the substrate body by a cement.

5. A method for the manufacture of an antibacterial surface on a substrate body, comprising the steps of:
providing a substrate body having an uppermost surface area including an antimicrobial material,
heating the substrate body until the surface area including an antimicrobial material reaches a gel-like consistency and
applying the antimicrobial spherical adsorbent to the gel-like surface area which includes the antimicrobial material so as to be embodied therein.

6. The method according to claim 5, wherein the uppermost surface is formed by fixing an antimicrobial material together with adsorbents on the surface of the substrate body by a cement material

7. A method for the manufacture of an antibacterial surface on a substrate body, comprising the steps of:
providing a substrate body,
applying to the substrate body a surface layer including an antimicrobial material,
heating the substrate body until the surface layer including the antimicrobial material until the surface layer reaches a gel-like soft state and
applying the spherical adsorbents to the gel-like surface layer so that the spherical adsorbents are embedded in the surface layer.
